(19) United States
(12) Patent Application Publication
(10) Pub. No.: US 2021/0169715 A1
(43) Pub. Date: Jun. 10, 2021

(54) WHEELCHAIR

(71) Applicants: Colin Gallois, Lille (FR); Lancelot Durand, Lille (FR)

(72) Inventors: Colin Gallois, Lille (FR); Lancelot Durand, Lille (FR)

(21) Appl. No.: 17/045,449

(22) PCT Filed: Apr. 3, 2019
(86) PCT No.: PCT/FR2019/050766

§ 371 Date: Oct. 5, 2020

(30) Foreign Application Priority Data
Apr. 3, 2018 (FR) 1852876

(51) Int. Cl. A61G 5/02; A61G 5/10

(52) U.S. Cl. CPC A61G 5/028; A61G 5/1027

(57) ABSTRACT

A wheelchair comprises a frame and two main wheels each coupled to a hand rim for actuating the wheels in both directions of rotation and for braking.

### CROSS-REFERENCE TO RELATED APPLICATIONS

This application is a national phase entry under 35 U.S.C. § 371 of International Patent Application PCT/FR2019/050766, filed Apr. 3, 2019, designating the United States of America and published as International Patent Publication WO 2019/193277 A1 on Oct. 10, 2019, which claims the benefit under Article 8 of the Patent Cooperation Treaty to French Patent Application Serial No. 1852876, filed Apr. 3, 2018.

### TECHNICAL FIELD

The present disclosure concerns the field of non-motorized wheelchairs for the elderly or disabled.

These wheelchairs must be light, very robust and enable easy manual movement.

For this purpose, wheelchairs usually have two side drive wheels driven by a hand-rim enabling the user to turn the wheel, possibly at different speeds in order to steer the wheelchair, and also to brake the wheelchair.

### BACKGROUND

The state of the art discloses French patent FR685706 concerning a freewheel and backpedaling brake hub for tricycles, invalid carriages, etc., adapted to enable the wheel to be driven in the reverse direction, by the use of a ratchet mechanism interposed between the cycle, etc., a fork and a member carrying the brake band, etc., and adapted to prevent the rotation of such member in the forward direction, but to allow its rotation in the backward direction, with sufficient friction to permit the operation of the brake. The driving chain plate is mounted on a sleeve having a screw thread engaging in a member, which drives the hub in the forward direction (Arrow F) through a pawl-and-ratchet mechanism permitting a freewheel action. On back-pedaling (Arrow B), the member is traversed by the screw thread so as to engage its conical clutch part in a cup, which then rocks a lever about its pivot on a plate, to expand a band into contact with a brake drum.

This document mainly concerns a cycle wheel of the back-pedaling type with one (single) wheel for a cycle with a fork for one single rear wheel.

A “carriage for the maimed” disclosed, in 1929 (the date on which this patent was filed), a tricycle with only one drive wheel at the back, driven in the manner of a bicycle wheel.

This document never refers to the operation of the wheel by a hand-rim (and it is difficult to see where it would be fixed on a “carriage for the maimed”), nor to the use of two wheels (if they were not paired but arranged on either side of a device, the latter could not move forward), let alone the use of two wheels with different structures.

A “carriage for the maimed” cannot be likened to a wheelchair.

Furthermore, Japanese patent JPH06 165799 discloses a wheelchair that comes to a stop positively at a position where it is oriented in an advancing direction without braking it halfway through a slope by allowing the wheelchair to have a simply designed and lightly switchable back stop function. A switching handle is turned counterclockwise when a wheelchair is rolled outdoors or is about to climb up an ascending slope. Then when the wheelchair is located halfway through a slope, and its user keeps his hand off the hand-rim, a one-way clutch with a bearing becomes firmly engaged, while a wheel hub tends to rotate clockwise, and thus no wheel rotation occurs. That is, the wheel hub can rotate counterclockwise but cannot rotate clockwise, preventing the wheelchair from rolling backward. If the switching handle is rotated clockwise, a cylindrical claw climbs up along the claw of a cylindrical bolt to permit an engagement between the crests of the claws. Furthermore, a pin slides out of a hole in the wheel hub, so that the wheel hub is completely separated from a hub shaft and the wheel hub can rotate freely again.

This patent describes a solution requiring an operating lever and does not enable braking, forward travel and reverse travel by a single action on the same element, namely the hand-rim of each of the drive wheels.

U.S. Pat. No. 5,027,930 describes a coaster brake assembly brake, which is coupled directly to a drive shaft. The drive shaft has a threaded driver integral thereon. A clutch cone having internal threads traverses in axial directions as it threads on or off the driver depending on the rotation of the driver. A brake cone is provided, which has a smooth axial bore through which the drive shaft rotates. The axial movement of the clutch cone toward the brake cone operates to force brake shoes against the inside wall of the hub. A spring is provided to facilitate the threading action between the clutch cone and the driver.

This patent describes a bicycle comprising only one drive wheel, with no hand-rim to drive it.

### BRIEF SUMMARY

The solutions of the prior art closest to the present disclosure concern non-motorized wheelchairs driven by hand-rims on which the user exerts repeated pushes. To brake, the user blocks the hand-rim with the palm of his hand. When the braking torque is high, it is usual for the user to apply pressure intermittently so as not to burn the palm of the hand.

In order to overcome these drawbacks, the present disclosure concerns, in the broadest sense, a wheelchair comprising a frame and two main drive wheels (the drive being human) each coupled to a hand-rim for actuating the wheels in both directions of rotation and for braking characterized in that the frame is equipped:
on the right-hand side in relation to the normal direction of movement
   with a connecting means with a side shaft locking in the clockwise direction and freely rotating in the counterclockwise direction
   the right hand-rim being mounted freely rotating in relation to the side shaft, without freedom of axial translation
   the right wheel being provided with a hub connected to the hand-rim by a connecting means locking in the clockwise direction
   the hub comprising a means of braking the rotation of the hub in relation to the side shaft, actuated by the counterclockwise movement of the hand-rim in relation to the side shaft
on the left-hand side in relation to the normal direction of movement
   with a connecting means of a side shaft locking in the counterclockwise direction and freely rotating in the clockwise direction
   the left hand-rim being mounted freely rotating in relation to the side shaft, without freedom of axial translation
   the left wheel being provided with a hub connected to the hand-rim by a connecting hub locking in the counterclockwise direction
   the hub comprising a means of braking the rotation of the hub in relation to the side shaft, actuated by the counterclockwise movement of the hand-rim in relation to the side shaft.

The “clockwise” or “counterclockwise” direction is understood to relate to when the wheel is observed from outside the wheelchair.

The braking means are assured by two complementary surfaces in relative motion, for example, the tapered surface of an axially mobile unit with a complementary tapered surface inside the hub.

According to a variation, the means of connecting the side shafts to the frame are formed by roller freewheels.

According to another variation, the means of connecting the side shafts to the frame are formed by ratchet freewheels.

According to another possible variation, the connection area of the frame is located between the connecting means of a side shaft on the one hand, and the wheel and hand-rim on the other.

According to a particular embodiment, the means of connecting the side shaft to the frame comprise a rapid-connection means of the side shaft.

The present disclosure also concerns a kit comprising a pair of wheels for a wheelchair formed by an assembly intended for the right-hand side of the wheelchair in relation to the normal direction of movement, formed by
a right hand-rim mounted freely rotating in relation to a side shaft, with no freedom of axial translation
the right wheel being provided with a hub connected to the hand-rim by a connecting means locking in the clockwise direction
the hub comprising a means of braking the rotation of the hub in relation to the side shaft, actuated by the counterclockwise movement of the hand-rim in relation to the side shaft.

The two wheels of the kit are of different types as regards the direction of locking of the hub.

### BRIEF DESCRIPTION OF THE DRAWINGS

A better understanding of the present disclosure will emerge from the following detailed description of a non-limiting example of an embodiment of the present disclosure made with reference to the accompanying drawings, in which:

FIG. 1 represents an exploded view of a wheelchair according to the present disclosure;

FIG. 2 represents a cross-sectional view of the wheel according to a first embodiment where the flange containing a roller freewheel is positioned between the main shaft and the frame;

FIG. 3 represents a cross-sectional view of the wheel according to a second embodiment where the flange containing a roller freewheel is positioned inside the wheelchair;

FIG. 4 represents a cross-sectional view of the wheel according to a third embodiment corresponding to a more compact embodiment than the first variation;

FIG. 5 represents a cross-sectional view of the wheel according to a fourth embodiment where the flange containing a roller freewheel is housed in the hub of the wheel;

FIGS. 6 and 7 represent a cross-sectional view of the wheel according to the fourth embodiment, with a rapid-connection system, in the disengaged position and the engaged position, respectively;

FIG. 8 represents a cross-sectional view and front view of the wheel with a variation of the rapid-connection system.

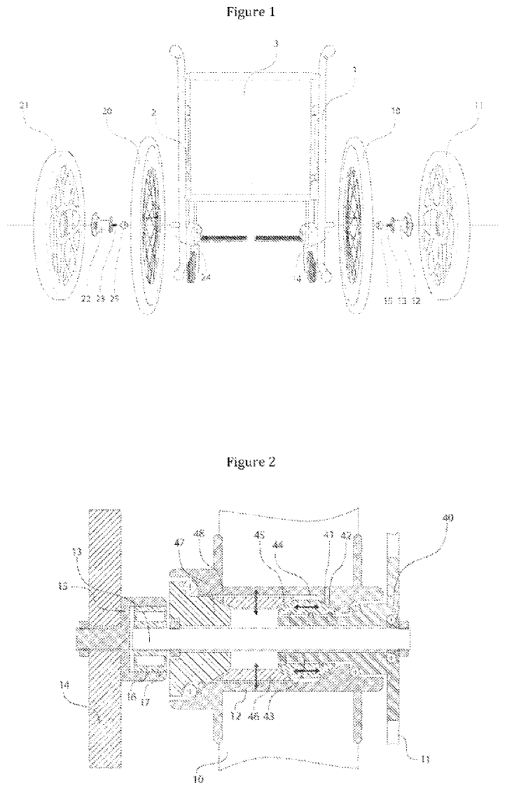

### DETAILED DESCRIPTION

The wheelchair is formed in general manner of a frame (1) supporting a seat (2) and a back (3).

The wheelchair comprises a right wheel (10) and a left wheel (20), in relation to the normal direction of movement of the wheelchair.

Each wheel (10, 20) can be actuated by a hand-rim (11, 21), respectively. The coupling between the left wheel (20) and the associated left hand-rim (21) is ensured by a left hub (22), the operation of which will be described below. The same applies to the coupling of the right wheel (10) to the right hand-rim (11), ensured by a right hub (12).

A shaft (23) passes through the hub (22) of the wheel (20) associated with the hand-rim (21), as well as the flange (25) integral with the structure (24). The inner end of the shaft (23) is held by a flange (25) containing a roller freewheel integral with the flange (25).

FIG. 2 represents a detailed view of the wheel according to a first variation where the flange containing a roller freewheel is positioned between the wheel and the frame of the wheelchair.

The flange (15) containing a roller (17) freewheel (16) is fixed to the frame (14) by means of a rod axially extending the surface opposite the hub. This rod is screwed to the frame of the wheelchair. It can also be fixed by a rapid-connection system. Such a rapid-connection system is formed, for example, by a rod extending the outer face of the flange and passing through the frame of the wheelchair. The rod can be retained by a lock actuated by a spring or any other known means.

This flange (15) contains a roller (17) freewheel (16) enabling the rotation of the shaft (13).

For the left wheel, the flange (25) contains a roller freewheel enabling the rotation of the shaft (23), integral with the wheel, in the clockwise direction (counter-trigonometric direction), but locking the rotation in the counterclockwise direction for the right wheel.

For this purpose, the freewheel (16) has, in a known way, inclined ramps. The rollers (17) engage between the inclined ramps and the cylindrical internal surface of the flange (15), assisted by a return spring acting on a roller cage. The friction between the rollers (17) and the inclined-ramp freewheel (16) on the one hand and between the rollers (17) and the flange (15) on the other, as well as the geometry of the parts, creates an over-center producing braking by adhesion. When the shaft (13) turns in the counterclockwise direction in relation to the flange, the rollers disengage and enable a free rotation in relation to the flange (15), for the right wheel, and in the clockwise direction for the left wheel.

The hand-rim (11) drives the wheel (40) provided with a screw thread (43).

The inner end of the wheel (40) has a screw thread (43) driving a mobile unit (44) having a ramp (45).

When the mobile unit (44) is moved axially outwards, its convex tapered outer end (41) comes into contact with the concave bearing surface (42) of the hub (12) integral with the right wheel (10) and thus ensures a coupling between the hand-rim (11) and the right wheel (10).

When the mobile unit (44) is moved axially inwards, it ensures the compression of a braking ring (46), the opposite end of which rests on a cone (47) and the outer face of which radially exerts a gradual friction on the hub (12) of the right wheel (10).

The characteristics of the hub, particularly the translational travel of the mobile unit, and the pitch of the screw thread are determined so that the movement from one end to the other is achieved by a relative angular travel between the hand-rim and the associated wheel of approximately 1°, and preferably between 0.1° and 10°, and more preferably between 0.1° and 2°.

According to a variation, a return screw pushes the hand-rim, in the absence of force being applied thereto by the user, into its forward travel position. This spring is, for example, arranged in the hub so as to push the mobile unit outwards, in the opposite direction to the frame. Thus the mobile unit (44) is pushed to rest in a position where the convex tapered outer end (41) comes into contact with the concave bearing surface (42) of the hub (12), under the action of a spring, for example.

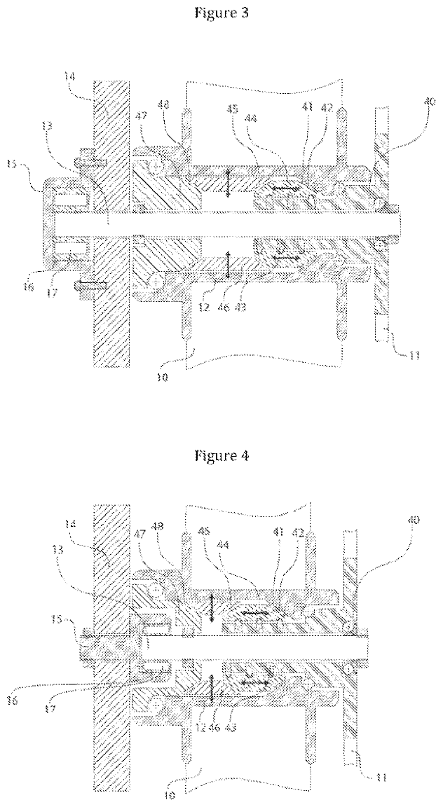

FIG. 3 represents a detailed view of the wheel according to a second variation where the flange containing a roller freewheel is positioned inside the wheelchair.

The wheel comprises a flange (15) coaxial with the hub (12).

The flange (15) is fixed to the inner surface of the frame (14) of the wheelchair, by welding or by bolts or rivets.

This flange (15) contains a roller (17) freewheel (16) enabling the rotation of the shaft (13), integral with the freewheel (16), in the counterclockwise direction (trigonometric direction), but locking the rotation in the clockwise direction for the right wheel.

For the left wheel, the flange (25) contains a roller freewheel enabling the rotation of the shaft (23), integral with the wheel, in the clockwise direction (trigonometric direction), but locking the rotation in the counterclockwise direction for the right wheel.

For this purpose, the freewheel (16) has, in a known way, inclined ramps. The rollers (17) engage between the inclined ramps and the cylindrical inner surface of the flange (15), aided by a return spring acting on a roller cage. The friction between the rollers (17) and the inclined-ramp freewheel (16) on the one hand, between the rollers (17) and the flange (15) on the other, as well as the geometry of the parts, creates an over-center producing braking by adhesion. When the shaft (13) turns in the counterclockwise direction in relation to the flange, the rollers disengage and enable a free rotation in relation to the flange (15), for the right wheel, and in the clockwise direction for the left wheel.

The hand-rim (11) drives the wheel (40) provided with a screw thread (43).

The inner end of the wheel (40) has a screw thread (43) driving a mobile unit (44) having a ramp (45).

When the mobile unit (44) is moved outwards, its convex tapered outer end (41) comes into contact with the concave bearing surface (42) of the hub (12) integral with the right wheel (10) and thus ensures a coupling between the hand-rim (11) and the right wheel (10).

When the mobile unit (44) is moved axially inwards, it ensures the compression of a braking ring (46), the opposite end of which rests on a cone (47) and of which the outer face radially exerts a gradual friction on the hub (12) of the right wheel (10).

FIG. 4 represents a third variation. The wheel is distinguished from the first variation by the fact that the flange (15) is fixed to the outer ring of the roller (17) freewheel (16). The inner ring of the ball freewheel is fixed to the side shaft (13).

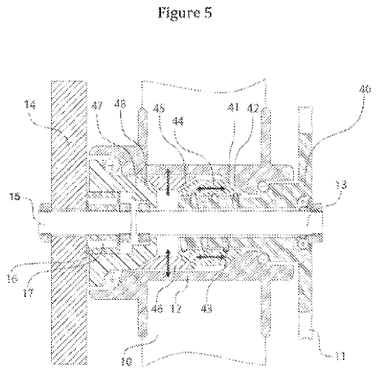

FIG. 5 shows another variation of the system, with the advantage of being more compact. Compactness enabling the user, among other things, to pass through doorways.

The kinematics of the system are identical to the variations described above. The difference with this variant lies in the fact that the means (15) connecting the side shafts to the frame are located in an internal recess of the cap (47) securing the hub.

The connection of the side shaft (13) to the frame is still achieved via a connection means locking in the clockwise direction and rotating freely in the counterclockwise direction. The outer ring of the roller (17) freewheel (16) is fixed to an internal face of the cap (47) itself integral with the side shaft (13). The inner ring of the ball freewheel is fixed to the frame, via a second side shaft (13).

The present disclosure also relates to a pair or wheels associated with the above-mentioned mechanisms, to enable the transformation of an existing wheelchair.

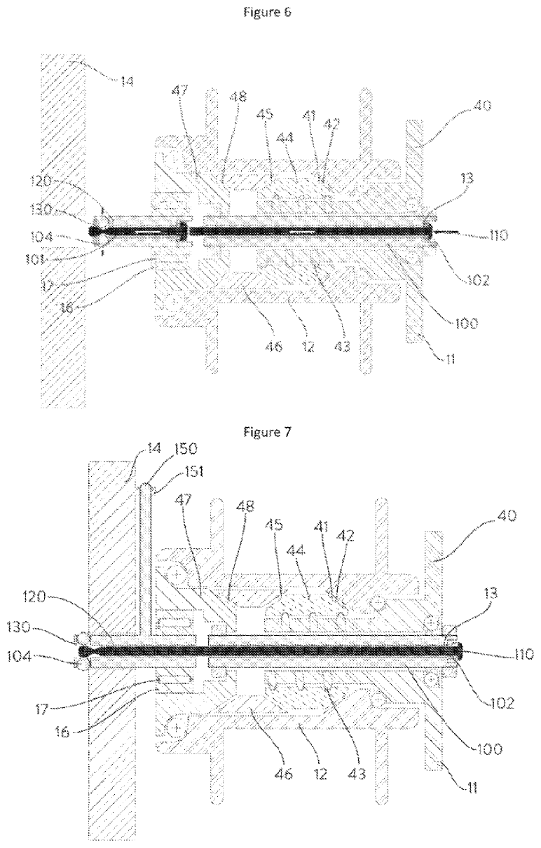

A particular variation shown in FIGS. 6 and 7 concerns the fixing of wheels onto the frame of a wheelchair by means of a rapid-connection system when the wheel is separated from the wheelchair and when the wheel is fixed to the wheelchair, respectively.

Such a system is formed by a rod made up of two coaxial and contiguous portions (100 and 120), the forward front end of the portion (100) coming into contact with the rear front end of the portion (120), both portions (100, 120) being free in relative rotation.

In the example described, the rod formed by the two portions (100, 120) has a coaxial pin (110) passing through it. Alternatively, this rod can be made as a single portion passing through the entire wheel hub.

The first portion (100) passes through the hub and the hollow shaft (13).

The second portion (120) passes through the shaft of the roller freewheel (16).

The wall of the front end of the portion (120) has apertures for the passage of balls (104) radially mobile between one position where they form a protuberance in relation to the outer surface of the portion (120), thus increasing the cross-section, and one centripetal position where they are flush. Depending on the position of the balls, the section of the front part of the portion (120) enables engagement in a housing of the wheelchair frame with a complementary section to the section of the portion (120), when the balls are in a centripetal position, and when the balls are driven outwards, ensures the locking of the portion (120) in the wheelchair frame.

A pin (110) passes through both portions (100, 120) and at its front end has an annular groove extended forwards by a truncated-cone-shaped end part enabling the balls to be pushed back when the pin (110) engages in the inner channel of both portions (100, 120). The annular groove has a radius of curvature complementary to the radius of the balls (104). When this groove is pushed back to the balls, they can move into a centripetal position. At rest, a spring (102) pushes the pin (110) backwards and the annular groove moves so that the balls are driven into a centrifugal position by the tubular section of the pin (110).

The rapid-connection system is provided with an anti-rotation means, formed by a tab (150) the end of which is designed to be fixed to a fixed part of the wheelchair frame. The end of this tab (150) has an aperture to engage a lug (151) extending the surface of the wheelchair frame.

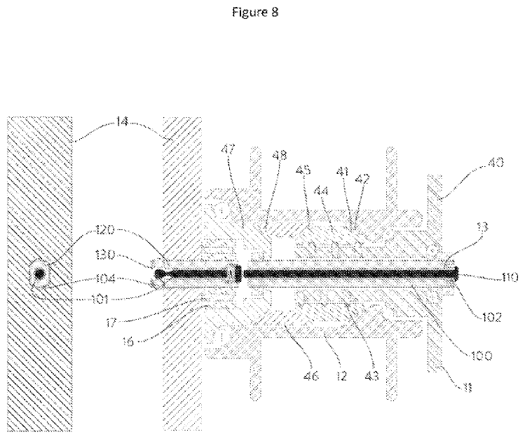

In the example shown in FIG. 8, this anti-rotation means is formed by a flat piece with a cross-section complementary to that of the front end of the portion (120).

1.-10. (canceled)

11. A wheelchair, comprising:
a frame; and
two main drive wheels each coupled to a hand-rim for actuating the wheels in both directions of rotation and for braking;
wherein the frame is equipped, on the right-hand side in relation to the normal direction of movement, by a right connecting means, with a right side shaft locking in a clockwise direction and freely rotating in a counterclockwise direction, a right hand-rim being mounted freely rotating in relation to the right side shaft, without freedom of axial translation, a right wheel being provided with a hub connected to the hand-rim by a connecting means locking in the clockwise direction, the hub comprising a means of braking the rotation of the hub in relation to the right side shaft, actuated by a counterclockwise movement of the hand-rim in relation to the right side shaft;
wherein the frame is equipped, on the left-hand side in relation to the normal direction of movement, by a left connecting means, with a left side shaft locking in the counterclockwise direction and freely rotating in the clockwise direction, a left hand-rim being mounted freely rotating in relation to the left side shaft, without freedom of axial translation a left wheel being provided with a hub connected to the hand-rim by a connecting hub locking in the counterclockwise direction the hub comprising a means of braking the rotation of the hub in relation to the left side shaft, actuated by the counterclockwise movement of the hand-rim in relation to the left side shaft.

12. The wheelchair of claim 11, wherein the right and left connecting means are formed by roller freewheels.

13. The wheelchair of claim 11, wherein the left and right connecting means comprise ratchet freewheels.

14. The wheelchair of claim 11, wherein connection areas of the frame are respectively located between the left and right connecting means and the wheels.

15. The wheelchair of claim 11, wherein the left and right connecting means comprise rapid-connection means of the left and right side shafts.

16. A pair of wheel assemblies for a wheelchair, comprising:
a right-hand side assembly including a right hand-rim mounted freely rotating in relation to a right side shaft with no freedom of axial translation, a right wheel provided with a right hub connected to the right hand-rim by a right connecting means locking in the clockwise direction, the right hub comprising a right braking means for braking the rotation of the right hub in relation to the right side shaft, the right braking means being actuatable by a counterclockwise movement of the right hand-rim in relation to the right side shaft; and
a left-hand side assembly including a left hand-rim mounted freely rotating in relation to a left side shaft with no freedom of axial translation, a left wheel provided with a left hub connected to the left hand-rim by a left connecting means locking in the counterclockwise direction, the left hub comprising a left braking means for braking the rotation of the left hub in relation to the left side shaft, the left braking means being actuatable by a clockwise movement of the left hand-rim in relation to the left side shaft.

17. The pair of wheel assemblies of claim 16, wherein each of the right and left wheels comprises a rapid-connection system.

18. The pair of wheel assemblies of claim 17, wherein the rapid-connection system is formed by a rod formed by two sections free in relative rotation with a coaxial pin passing through the rod, a wall of a front end of a portion having apertures for a passage of balls radially mobile between one position where they form a protuberance in relation to an outer surface of the portion, thus increasing a cross-section, and one centripetal position where they are flush, the balls cooperating with an annular groove provided at a front of the pin.

19. The pair of wheel assemblies of claim 18, wherein the rapid-connection system further comprises an anti-rotation mechanism formed by a tab, an end of the tab configured to be fixed to a wheelchair frame.

20. The pair of wheel assemblies of claim 18, wherein the rapid-connection system further comprises an anti-rotation mechanism formed by a flat piece formed at the front end of the portion of the rod.
